(19) United States
(12) Patent Application Publication
(10) Pub. No.: US 2022/0304472 A1
(43) Pub. Date: Sep. 29, 2022

(54) CONNECTING FITTING, ITEM OF FURNITURE, DEVICE FOR CONNECTING FURNITURE PARTS, AND METHOD FOR ASSEMBLING A PIECE OF FURNITURE

(71) Applicant: Hettich Franke GmbH & Co. KG, Balingen-Weilstetten (DE)

(72) Inventors: Steffen GRATHWOL, Balingen (DE); Benjamin SAUTER, Albstadt (DE); Marcel SCHLAICH, Geislingen (DE); Philipp STEEB, Bodelshausen (DE)

(73) Assignee: Hettich Franke GmbH & Co. KG, Balingen-Weilstetten (DE)

(21) Appl. No.: 17/641,487

(22) PCT Filed: Sep. 1, 2020
(86) PCT No.: PCT/EP2020/074321

§ 371 Date: Mar. 9, 2022

(30) Foreign Application Priority Data
Sep. 10, 2019 (DE) 10 2019 124 306.8
Jun. 2, 2020 (DE) 10 2020 114 675.2

(51) Int. Cl. A47C 13/00; F16B 12/60

(52) U.S. Cl. CPC A47C 13/005; F16B 12/60

(57) ABSTRACT

A connecting fitting for a piece of furniture, in particular an item of upholstered furniture, has a first part which can be fixed to a first furniture part and a second part which can be fixed to a second furniture part, the first part having a receptacle for a bearing edge of the second part and the second part being pivotable relative to the first part about the bearing edge within a first angular range.

The present invention relates to a connecting fitting for a piece of furniture, in particular an item of upholstered furniture, having a first part which can be fixed to a first furniture part and a second part which can be fixed to a second furniture part, the first part having a receptacle for a bearing edge of the second part and the second part being pivotable relative to the first part about the bearing edge within a first angular range, to an item of furniture, to a device for connecting pieces of furniture, and to a method for assembling a piece of furniture.

DE 20 2017 107 179 U1 discloses a piece of furniture in which two furniture parts are fixed to each other via two different connections. At a first connection, the two furniture parts can be mounted so as to be pivotable relative to each other, and at a second connection, a latching takes place. Numerous components are required for fixing the two furniture parts, which must be mounted in a positionally accurate manner in order to ensure a secure connection of the two furniture parts. Assembly can only be carried out by a specialist.

DE 10 2016 100 753 A1 discloses a furniture fitting for connecting furniture parts, in which two shafts are provided which are displaceable relative to one another. The shafts are pretensioned relative to each other by means of a spring, so that the two fitting parts can be latched to each other. This simplifies assembly, but numerous components are required to produce the two fitting parts.

It is therefore the object of the present invention to provide a connecting fitting which, with a simple structure, ensures secure fixing of furniture parts to one another. In addition, a device for connecting furniture parts which is easy to assemble and a method for assembling a piece of furniture are to be provided which can also be carried out by persons with little experience.

This object is solved with a connecting fitting having the features of claim 1, a device having the features of claim 13, and a method for assembling a piece of furniture having the features of claim 15 or 17.

The connecting fitting according to the invention has two parts which can be locked together by a simple movement in order to fix two furniture parts together. A receptacle for a bearing edge of the second part is provided on the first part, so that the second part can be pivoted relative to the first part about the bearing edge in a first angular range. In this first angular range, the first part and the second part contact each other only via the bearing edge and the receptacle. The first part further comprises a guide surface, which can be contacted by a sliding surface on the second part. Once the sliding surface on the second part contacts the guide surface, the first part can be pivoted relative to the second part along a second angular range that is contiguous with the first angular range. During this pivoting along the second angular range, the sliding surface on the second part moves along the guide surface so that, in addition to the pure rotational movement, a translational movement is caused by the guide. At the end of the guide surface, the first part comprises a locking element to which the second part can be locked against pivoting. This allows the second part to be locked by a simple pivoting movement relative to the first part, wherein the two parts are secured against pivoting movement in the locked position.

The locking element can be formed as a recess into which a projection of the second part can be inserted. In this way, locking can be effected in a simple manner, wherein the second part is preferably translationally displaced in a first direction when pivoted over the guide surface and is moved in the second direction opposite to the first direction for locking, in order to be locked to the first part. As a result, release of the connection between the first and second parts can only be achieved by sliding the second part relative to the first part and then pivoting it. Without such a sliding movement, the two parts are securely locked against pivoting.

A bent web is preferably provided on the first part, on which the guide surface is formed. The guide surface preferably extends inclined to a circumferential direction along which the sliding surface is moved during pivoting to displace the second part relative to the first part.

For a secure mounting of the second part on the first part, a U-shaped or L-shaped bent receptacle may be formed on the first part. During assembly, the bearing edge can then be inserted into this angled or bent receptacle in order to then be pivoted over a certain angular range.

In a further design, the second part has an opening into which a bent web having the guide surface of the first part can be inserted. In this way, the second part can be secured against displacement parallel to the longitudinal direction of an axis of rotation of the pivoting movement. Preferably, a projection is formed at an opening which is insertable into the recess on the first part. Thereby, by engaging the projection, a locking of the first part to the second part against a pivoting movement can be effected.

For improved guidance of the pivoting movement, the bearing edge on the second part can be arranged between two centering projections, wherein the centering projections engage around the receptacle on the first part during pivoting. This prevents displacement of the second part in the direction of the axis of rotation via the centering projections.

For a simple fixation to a furniture part, the first part may comprise a flat base surface to which a fixation of the first furniture part is performed via fastening means, in particular one or more screws. The second part may also have a flat base surface to which the second furniture part is fixed by fastening means, such as screws.

Preferably, the first part and/or the second part are made of a bent metal sheet, so that the connecting fitting can be easily manufactured. Preferably, the connecting fitting comprises only the two parts made of a bent metal sheet, each of which is then fixed to a furniture part by fastening means.

According to the invention, the connecting fitting is used in furniture, for example in seating furniture such as sofas or armchairs, to fix armrests, headboards or other furniture parts to a base part, or also to connect two or more furniture base parts, wherein each base part itself stands on the floor. Preferably, the furniture parts may be connected together by two separate connecting fittings and a single pivoting movement.

A device according to the invention for connecting furniture parts, in particular furniture parts of an upholstered piece of furniture, comprises a first connecting fitting having a first part which can be fixed to a first furniture part and a second part which can be fixed to a second furniture part, and a second connecting fitting having a first part which can be fixed to the first furniture part and a second part which can be fixed to the second furniture part, wherein the first part of the second connecting fitting comprises a receptacle for a bearing edge of the second part of the second connecting fitting, and the second part is pivotable relative to the first part about the bearing edge in an angular range. In this case, a guide surface is provided on the first part of the first connecting fitting, which guide surface contacts the second part of the first connecting fitting with a sliding surface during pivoting and additionally translationally displaces the second part relative to the first part, and the first part has, at the end of the guide surface, a locking element on which the second part can be locked against pivoting. The locking may be effected, for example, by a projection on the second part engaging a recess on the first part at the end of the sliding surface.

In the first method according to the invention for assembling a piece of furniture having a first piece of furniture, to which a first part is fixed, and a second piece of furniture, to which a second part of the connecting fitting is fixed, a bearing edge of the second part is first placed against a receptacle of the first part. Then, the second part is pivoted relative to the first part about the bearing edge in a first angular range until a sliding surface on the second part contacts a guide surface on the first part. Then, the second part is further pivoted about the bearing edge in a second angular range, wherein the sliding surface on the second part is moved along the guide surface on the first part, so that in addition to the pivoting movement, there is also a translational displacement of the second part relative to the first part. At the end of the guide surface, the second part is then locked to the first part against pivoting. Preferably, the locking is effected by an engagement of a projection on an opening of the second part which is inserted into a recess on the first part, preferably via a translational movement which is opposite to the movement that occurs during pivoting. In other words, if the second part is raised slightly relative to the first part during pivoting, the second part can be lowered relative to the first part for locking, and during this lowering a projection of the second part engages the first part. Alternatively, of course, a projection may be provided on the first part to engage an opening on the second part.

In the second method according to the invention for assembling a piece of furniture comprising a first piece of furniture to which a first part and a second piece of furniture to which a second part of a connecting fitting is fixed, and a second connecting fitting comprising a first part which can be fixed to the first piece of furniture and a second part which can be fixed to the second piece of furniture, a bearing edge of the second part of the second connecting fitting is first applied to a receptacle of the first part of the second connecting fitting in order to then pivot the second part relative to the first part. Then, a sliding surface on the second part of the first connecting fitting is moved along a guide surface on the first part of the first connecting fitting during the pivoting, wherein the second part is additionally translationally displaced relative to the first part to then lock the second part to the first part at the end of the guide surface against a pivoting movement. Thereby, the translational movement of the second part during the pivoting movement about the bearing edge forming a pivot axis may be in a radial direction as well as perpendicular to the radial direction.

The invention is explained in more detail below with reference to the accompanying drawings with reference to several exemplary embodiments, wherein:

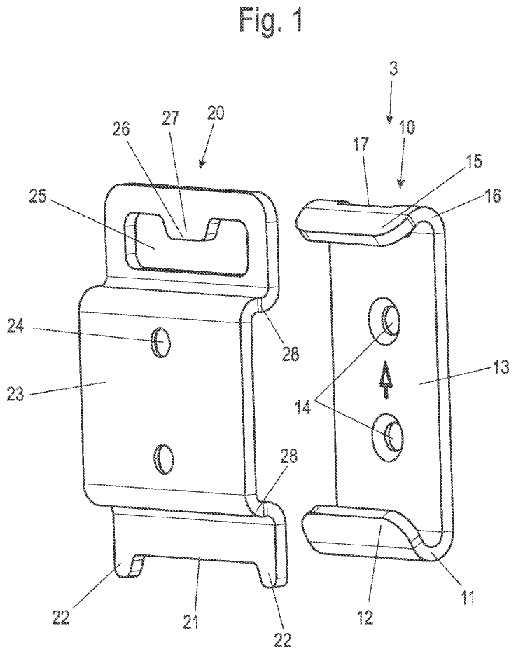

FIG. 1 shows an exploded perspective view of an exemplary embodiment of the connecting fitting according to the invention;

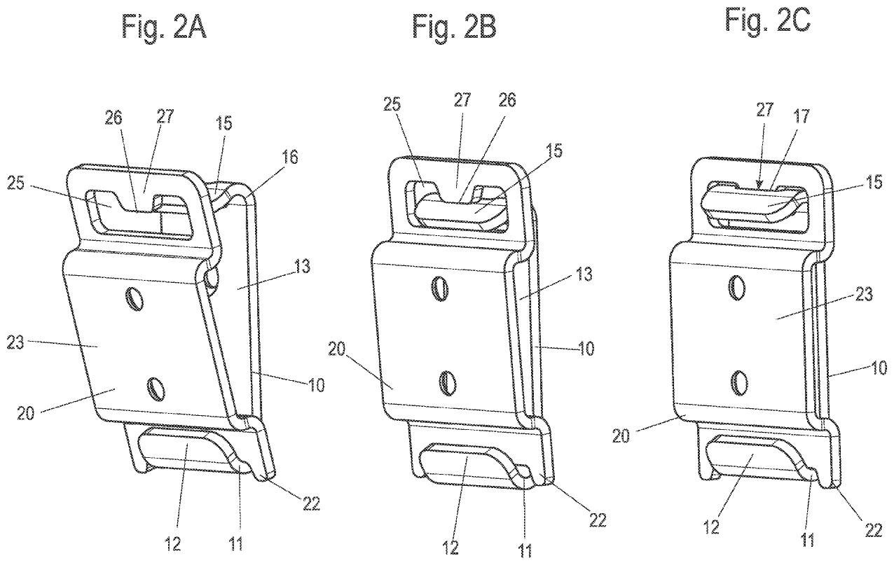

FIGS. 2A to 2C show several views of the two parts of the connecting fitting during assembly;

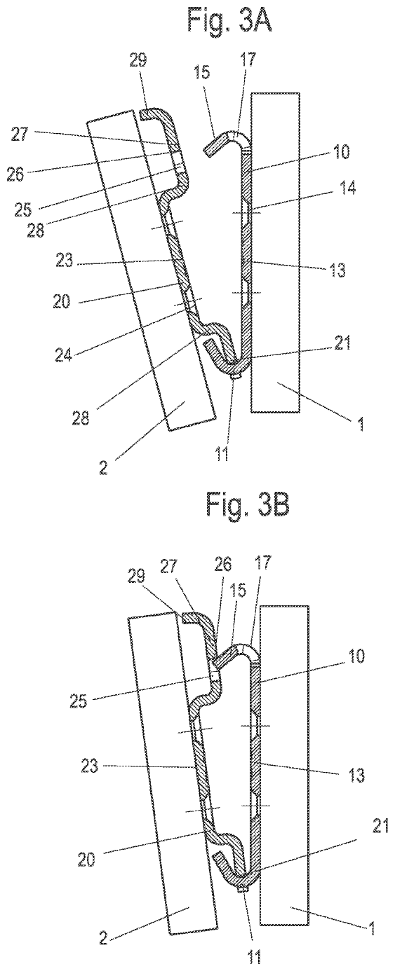

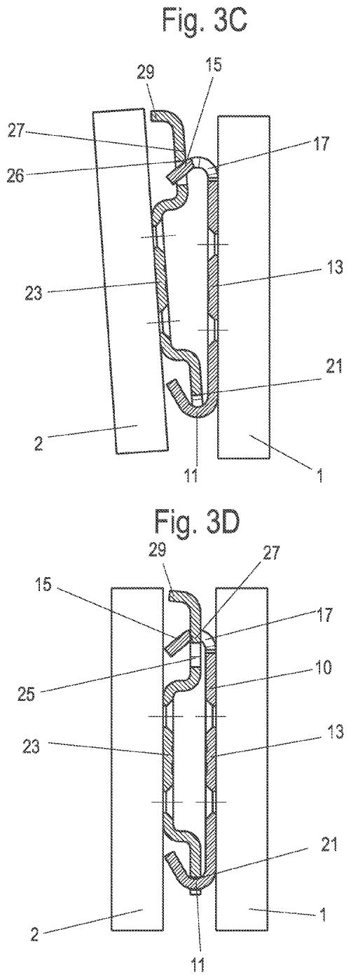

FIGS. 3A to 3D show four views of the connecting fitting of FIG. 1 with an optional stiffening bend during assembly with schematically illustrated furniture parts;

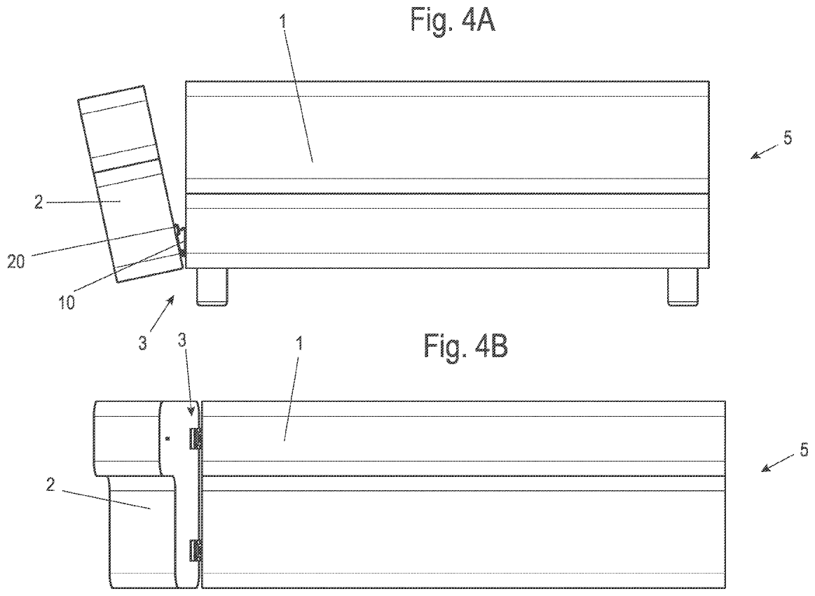

FIGS. 4A and 4B show two views of a piece of furniture when assembled over a connecting fitting;

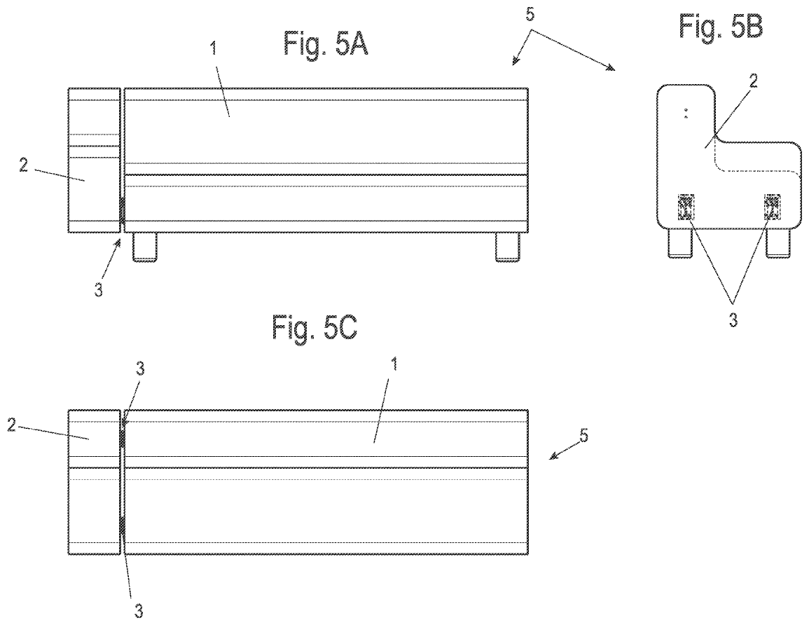

FIGS. 5A to 5C show several views of the piece of furniture of FIG. 4 in the assembled position;

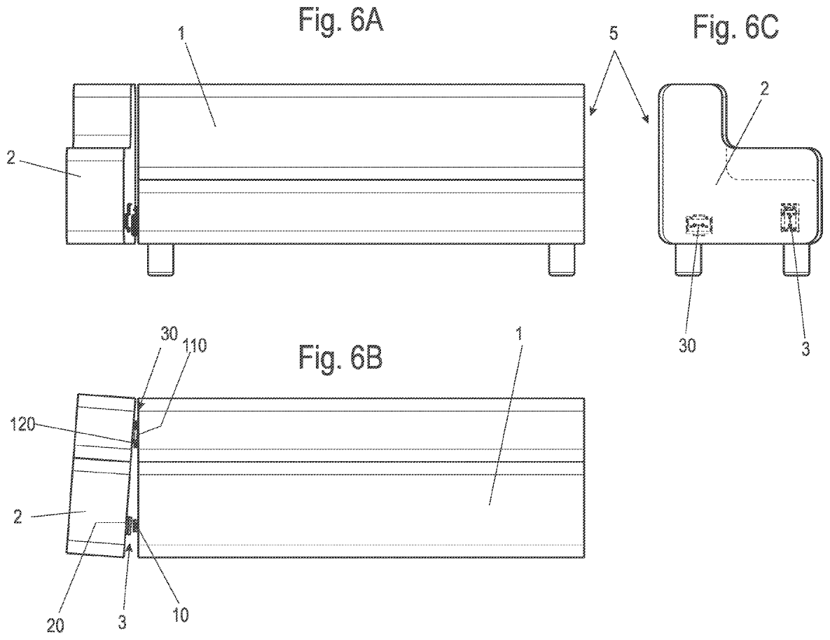

FIGS. 6A to 6C show multiple views of a modified piece of furniture during assembly of a connecting fitting;

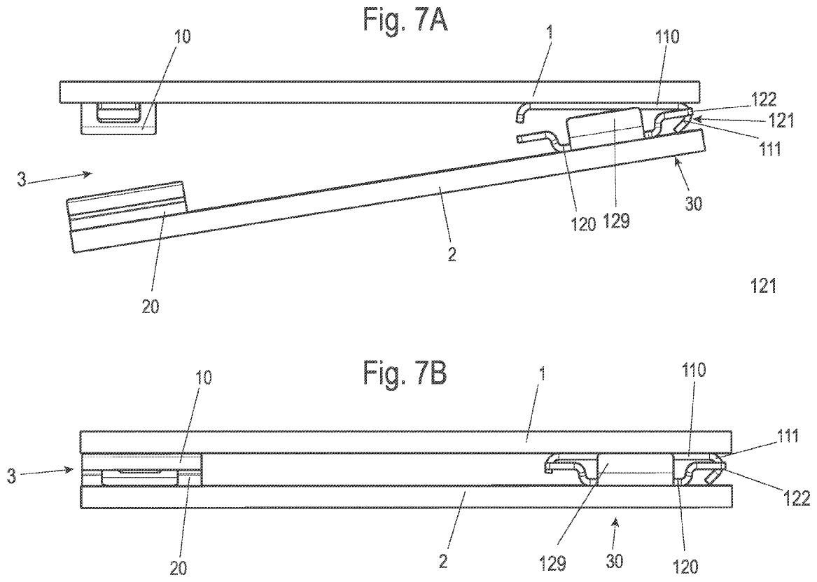

FIGS. 7A and 7B show two views of the connecting fitting of FIG. 6 with furniture parts shown schematically;

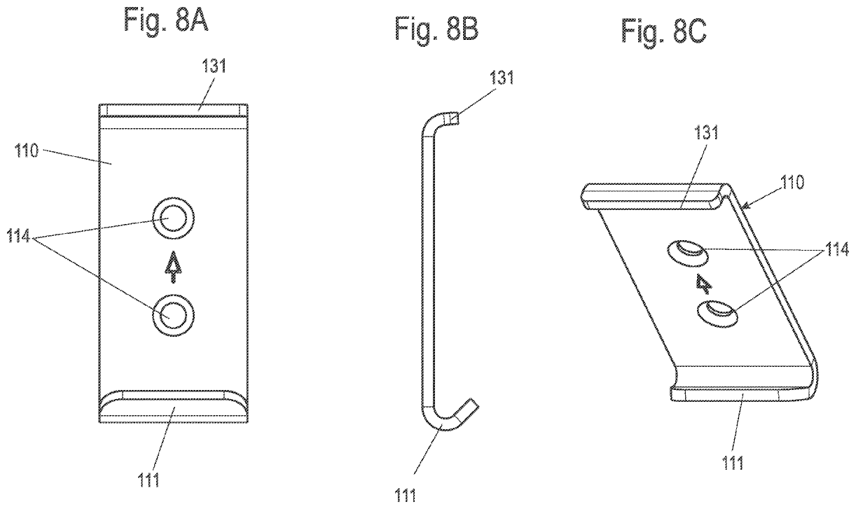

FIGS. 8A to 8C show three views of a first part of the connecting fitting of FIGS. 6 to 7;

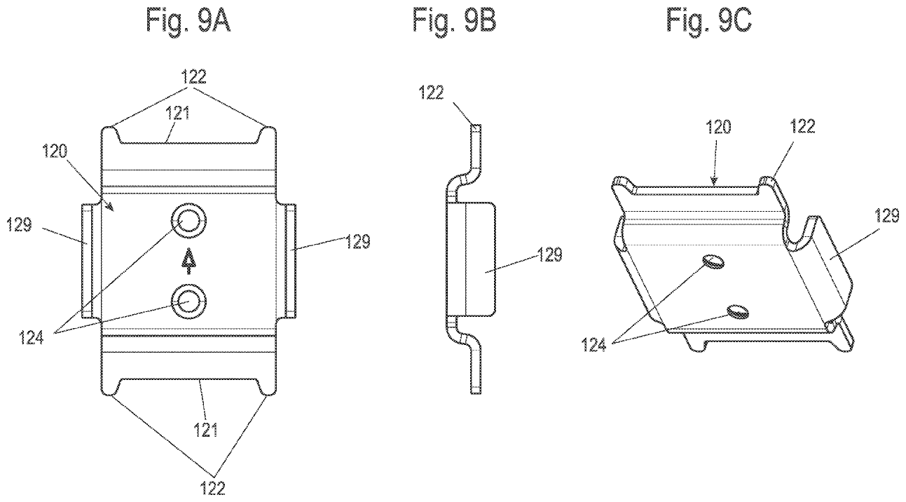

FIGS. 9A to 9C show three views of a second part of the connecting fitting of FIGS. 6 to 7;

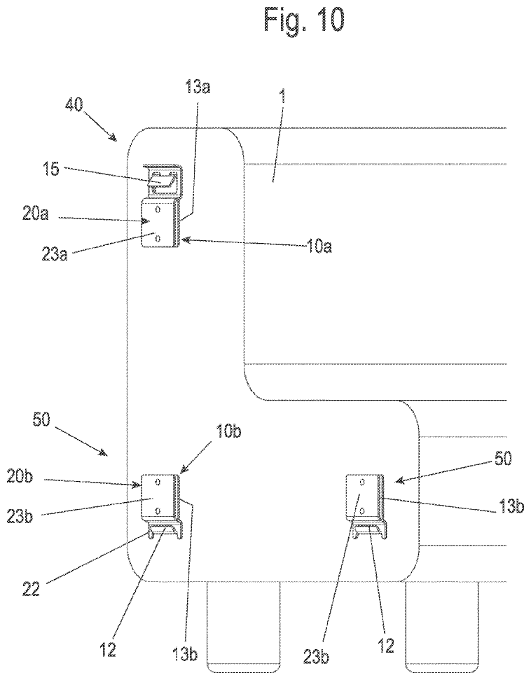

FIG. 10 shows a perspective view of a device for connecting furniture parts in an assembled position;

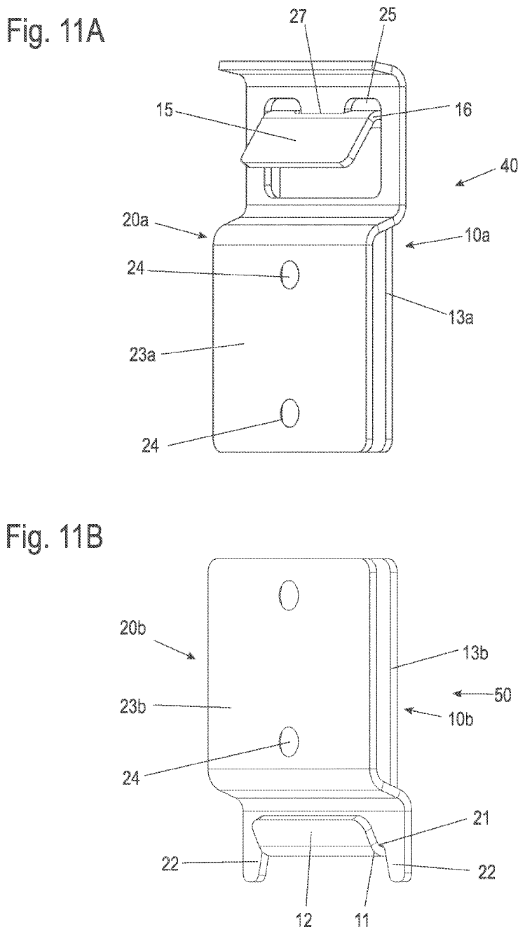

FIGS. 11A and 11B show two views of the device of FIG. 10 without furniture parts;

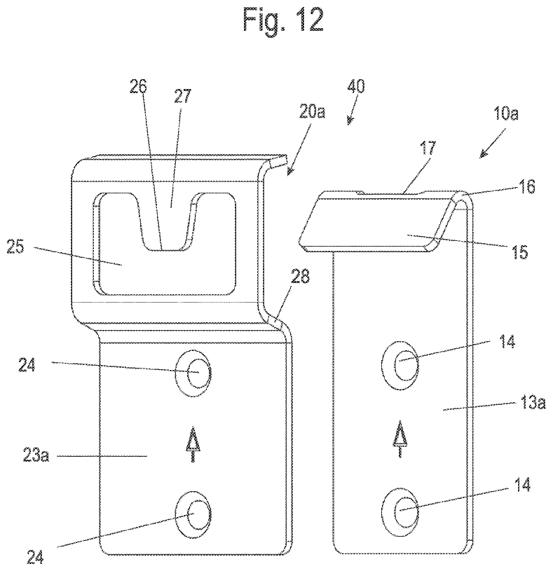

FIG. 12 shows a perspective view of the first connecting fitting of the device of FIG. 10 prior to assembly, and

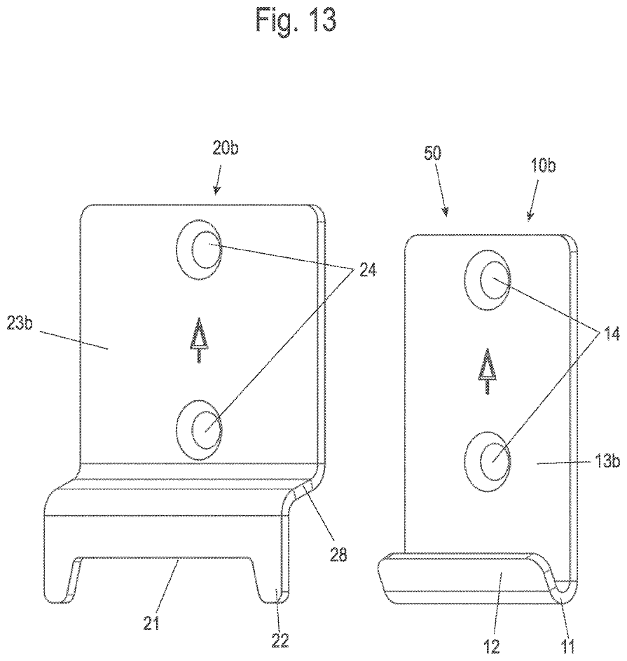

FIG. 13 shows a perspective view of the second connecting fitting of the device of FIG. 10 prior to assembly.

A connecting fitting 3 comprises a first part 10 and a second part 20. The two parts 10 and 20 are made of a bent metal sheet and formed by stamping and bending. Alternatively, the parts 10 and 20 may be made of plastic or another material, for example by injection molding or 3D printing.

The first part 10 is substantially rectangular in shape and comprises, at a first end face, a receptacle 11 produced by bending a web 12 at one end. This results in a channel-shaped receptacle 11, into which a bearing edge 21 of the second part 20 can be inserted.

The first part 10 comprises a flat base surface 13 on which openings 14 are cut out for fastening means, in particular for screws, in order to be able to fix the first part 10 to a first piece of furniture. The web 12 may be oriented at an angle to the flat base surface 13 of, for example, 90° to 20° to form a channel-shaped receptacle 11.

On the opposite side to the receptacle 11, a bend 16 is provided on the first part 10 at which an angled web with a guide surface 15 is formed. A recess 17 is formed in the region of the bend 16. The webs 12 and the web with the guide surface 15 face each other.

The second part 20 also comprises a planar base surface 23, on which openings 24 are recessed for fastening means to secure the second part 20 to a second furniture part. Steps 28 extend from this base surface on opposite sides, so that the two opposite end sections of the second part 20 are arranged in a plane offset from the base surface 23, but substantially parallel thereto. A bearing edge 21 is formed on a first end section, which is arranged between two protruding centering projections 22. The bearing edge 21 forms an axis of rotation for the second part 20 during assembly.

At the opposite end section of the second part 20, an opening 25 is recessed into which a projection 27 projects which is directed towards the bearing edge 21. A sliding surface 26 is formed on the projection 27, which can contact the guide surface 15 on the first part 10 during the assembly operation. The opening 25 is surrounded in a frame-like manner by the material of the second part 20.

The assembly of the connecting fitting 3 is shown in FIGS. 2A to 2C.

In a first step, the second part 20 is positioned on the first part 10 such that the bearing edge 21 is inserted into the receptacle 11. The two centering projections 22 thereby embrace the receptacle and secure the second part 20 against displacement parallel to the direction of an axis of rotation.

The second part 20 is now pivoted about the bearing edge 21 through a first angular range until the sliding surface 26 contacts the guide surface 15 at the projection 27. The pivoting process is then continued through a second angular range, in which angular range the sliding surface 26 is moved along the guide surface 15. As a result, the second part 20 no longer moves in a purely rotational motion, but is additionally displaced, wherein the second part 20 is displaced such that the bearing edge 21 is lifted from the receptacle 11, as shown in FIG. 2B. In this position, the centering projections 22 are still in contact around the receptacle 11 and prevent a displacement of the second part 20 relative to the first part 10.

At the end of the guide surface 15, the projection 27 with the sliding surface 26 enters the area of the recess 17 at the bend 16 of the first part 10. Then, the second part 20 is again displaced relative to the first part 10 so that the bearing edge 21 again rests against the receptacle 11. In doing so, the projection 27 engages the recess 17 of the first part 10 so that the second part 20 is secured to the first part 10 against pivoting. Release of the second part 20 can now only be effected by displacing the second part 20 to move the projection 27 out of the recess 17, and then pivoting back to release the two parts 10 and 20 from each other again. Alternatively, it is also possible for the projection 27 and/or its connection to the second part 20 to deform elastically and/or plastically as it slides over the sliding surface 26, given the appropriate dimensional design, and when it enters the recess 17 of the first part 10 there is thus increased security against unintentional release.

In FIGS. 3A to 3D, the assembly of the connecting fitting 3 of FIGS. 1 and 2 is shown in section, with a first furniture part 1, to which the first part 10 is fixed, and a second furniture part 2, to which the second part 20 is fixed, also being shown schematically.

In FIG. 3, the bearing edge 21 has been inserted into the receptacle 11 of the first part 10. Now the second furniture part 2 with the second part 20 can be pivoted about the bearing edge 21 until the sliding surface 26 on the projection 27 contacts the guide surface 15 on the bent web, as shown in FIG. 3B. If the pivoting movement is now continued, the second part 20 is not only pivoted but also displaced relative to the first part 10. This causes the bearing edge 21 to disengage from the receptacle 11, as shown in FIG. 3C. The sliding surface 26 slides along the inclined guide surface 15.

When the projection 27 and the sliding surface 26 reach the end of the guide surface 15, the projection 27 can be inserted into the recess 17 on the first part 10, as shown in FIG. 3D. Then, the second part 20 is again displaced relative to the first part 10 so that the bearing edge 21 again abuts the receptacle 11. The second part 20, and hence the second furniture part 2, is secured against pivoting in either direction relative to the first part 10 because the projection 27 abuts an edge of the guide surface 15 and pivoting in opposite directions is limited by the base surface 13.

In FIGS. 3A to 3D, an additional bend 29 is integrally formed on the second part 20 adjacent to the opening 25 and the projection 27. This bend 29 serves to stiffen and stabilize the second part 20, in particular to counteract permanent plastic deformation of the projection 27 or its connection. Another function of a bend 29 may be to increase the moment of resistance to bending of the material, in order to deliberately obtain an elastic behavior of the projection 27.

In FIGS. 4A and 4B a piece of furniture 5 according to the invention is shown, in particular a piece of seating furniture, such as a sofa, in which the first piece of furniture 1 is designed as a seat part and the second piece of furniture 2 is designed as a side part. The first furniture part 1 has the first part 10 fixed thereto, and the second furniture part 2 has the second part 20 fixed thereto. The connecting fitting 3 is oriented in such a way that the axis of rotation is substantially horizontal when the second part 20 is pivoted relative to the first part 10. In the position shown, the second furniture part 2 is arranged at an angle to the vertical, wherein two second parts 20 are fixed to the second furniture part 2, both of which engage in a receptacle 11 of a first part 10 on the first furniture part 1.

To fix the second furniture part 2 to the first furniture part 1, the second furniture part 2 with the two second parts 20 is now pivoted, as shown in detail in FIGS. 3A to 3D. Due to the horizontal orientation of the axis of rotation, the weight forces are first absorbed by the receptacle 11 before the second furniture part 2 with the second parts 20 is then raised slightly via the guide surface 15, in order to then be locked at the end of the guide surface 15 by the pivoting force, in that the projections 27 on the second parts 20 each engage in a recess 17 on a first part.

In FIGS. 5A to 5C, the assembled position of the piece of furniture 5 is shown with the second furniture part 2 locked to the first furniture part 1. Release of the second furniture part 2 can now only be achieved by lifting the second furniture part 2 relative to the first furniture part 1 to disengage the projection 27 from the recess 17, and then pivoting the second furniture part 2 again to disassemble the furniture parts.

In FIGS. 4A and 4B the pivot axis for fixing the furniture parts was horizontal. It is of course also possible to use the connecting fitting 3 in a different way.

In FIGS. 6A to 6C, an exemplary embodiment of a piece of furniture 5 is shown in which a first connecting fitting 3 according to the invention and a further second connecting fitting 30 are provided, comprising two parts 110 and 120 which are mounted such that the second piece of furniture 2 is pivoted about a vertical axis relative to the first piece of furniture 1 in order to make a fixation. The second furniture part 2 is fixed to the first furniture part 1 via the connecting fitting 3 according to the invention and the further connecting fitting 30.

FIGS. 7A and 7B schematically illustrate the assembly of the furniture part 2 to the first furniture part 1 according to FIG. 6. In the second part 120, a bearing edge 121 has been positioned on a curved receptacle 111 of the first part 110, with the two centering projections 122 engaging around the receptacle 111. In this exemplary embodiment, pivoting takes place about a vertical axis, wherein no translational movement is required at the connecting fitting 30 when pivoting in, as shown in the case of the connecting fitting 3. Instead, a curved abutment 131 of the first part 110 comes into abutment between the centering projections 122 of the second part 120. Securing against loosening of the furniture part 2 takes place by means of the connection which is created at the connecting fitting 3 when the furniture part 2 is pivoted in.

In this exemplary embodiment, however, the connection of the connecting fitting 3 is not effected by pivoting about a horizontal axis, but when the furniture part 2 is pivoted in about the vertical axis.

In the case of the connecting fitting 3, the sliding surface 26 of the second part 20 comes into contact with the guide surface 15 of the first part 10. As a result, the second part 20 is raised relative to the first part 10 by a predetermined distance until the projection 27 of the second part 20 plunges into the recess 17 of the first part 10, thus securing the connection. During this brief raising and lowering of the second part 20 of the connecting fitting 3, the vertical pivot axis of the connecting fitting 30 performs a slight angular deviation from the vertical in that the bearing edge 121 of the second part 120 abuts and slightly rotates about different regions of the receptacle 111.

In the assembled position, the combination of the connecting fittings 3 and 30 is thus secured against pivoting or displacement, in particular in the direction of gravity. To release this connection, the furniture part 2 must be lifted against the direction of gravity in the region of the connecting fitting 30, whereby the projection 27 comes out of engagement with the opening 17.

FIGS. 8A to 8C illustrate an embodiment of a first part 110 of the connecting fitting 30. A plate-shaped section of the first part comprises a plurality of openings 114 for fastening means. On a first side, the curved receptacle 111 is integrally formed and on the second side opposite to the first side, the curved abutment 131 is formed.

FIGS. 9A to C show an embodiment of a second part 120 of the connecting fitting 30. On each of two opposite sides of a plate-shaped section with openings 124, a bearing edge 121 is arranged between two centering projections 122. One of the two bearing edges 121 of the second part 120 represents a preferably vertical axis about which the furniture part 2 is pivoted. This bearing edge 121 comes into contact with the receptacle 111 of the first part 110 and pivots until the other bearing edge 121 is arranged adjacent to the curved abutment 131. When pivoting in, the abutment 131 of the first part 110 is positioned between the centering projections 122 of the second part 120, whereby the connection is fixed in two of three spatial directions.

Two lateral bends 129 are also provided on the second part 120, which serve as stiffeners to counteract deformations. Optionally or simultaneously, however, they may also serve as spacers between the first part 110 and the second part 120 to establish a predefined minimum distance between the parts.

The furniture part 2 is secured to the furniture part 1 by the additional connection of the first and second parts 10 and 20 of the connecting fitting 3, the assembly of which is described with reference to FIGS. 2 and 3.

Alternatively to the positive connection or abutment of the receptacle 11 or 111 between two centering projections 22 or 122 and/or the positive connection of the abutment 131 between two centering projections 122, another positive connection may be selected, for example by projections engaging in openings on the corresponding part.

For the purposes of the present invention, the arrangement of the first part 10 or 110 and second part 20 or 120 on the first furniture part 1 and the second furniture part 2 respectively is interchangeable. The parts can be usefully assembled in such a way that, depending on which furniture parts are to be connected and how gravity acts, the parts are arranged accordingly.

In FIG. 10, a device for connecting furniture parts is shown in which a first connecting fitting 40 and two second connecting fittings 50 are provided, although the number of connecting fittings 50 can also be designed differently, for example only one connecting fitting 50 or more than two connecting fittings 50 can be provided.

Each connecting fitting 50 comprises a first part 10b which can be fixed to the first furniture part 1, in particular via a base surface 13. A second part 20b can be fixed to the first part 10b, which can be fixed to the second furniture part. A receptacle is formed on the first part 10b between a web 12 and the base surface 13, on which a bearing edge of the second part 20b can be pivoted.

The first connecting fitting 40 comprises a first part 10a fixable to the first furniture part 1, and a second part 20a fixable to the second furniture part. A guide surface 15 is formed on the first part 10a, along which the second part 20a of the first connecting fitting 40 is displaced with a sliding surface when the second part 20b of the first connecting fitting 50 is pivoted about the bearing edge as a pivot axis. The displacement along the guide surface 15 takes place at least partially in the radial direction, i.e. in FIG. 10 in the vertical upward direction, until the end of the guide surface is reached and the second part with the second part 20a and the second part 20b is lowered to lock the connecting fitting 40.

In FIGS. 11A and 11B, the first connecting fitting 40 and the second connecting fitting 50 are shown without furniture parts. In the first connecting fitting 40, a recess is formed behind the guide surface 15 in which a projection 27 on the second part 20a engages. The recess is thereby formed in the region of a bend 16 on the first part 10a, which is fixed to a base surface 13a on the first furniture part 1.

On the second connecting fitting 50, a curved receptacle 11 is formed on the first part 10b which is used for accommodating a bearing edge 21 on the second part 20b. The bearing edge 21 is thereby received between a web 12 and the base surface 13b. Downwardly projecting centering projections 22 are formed laterally adjacent to the bearing edge 21 to prevent or limit displacement in the longitudinal direction of the bearing edge 21.

In FIG. 12, the first connecting fitting 40 is shown prior to assembly. The first part 10a comprises a base surface 13a with openings 14 for mounting to the first furniture part, and has a recess 17 in the region of a bend 16 for receiving the projection 27. Furthermore, adjacent to the bend 16, the guide surface 15 is integrally formed with the first part 10a. The second part 20a of the first connecting fitting 40 includes a base surface 23a having openings 24 for securing the second part 20a to the second furniture part. Integral with the base surface 23a and offset by a step 28 is an opening 25, in which a projection 27 with a sliding surface 26 projects downwardly. The sliding surface 26 can be displaced along the guide surface 15 during assembly.

In FIG. 13, the second connecting fitting 50 is shown prior to assembly. The first part 10b is fixable to the first furniture part 1 via the base surface 13b by fastening means which extend through openings 14. Integral with the base surface 13b are the receptacle 11 and the bent-over web 12.

The second part 20b of the second connecting fitting 50 includes the lower bearing edge 21 between the two centering projections 22 and the base surface 23b, which is offset via a step 28 and has openings 24.

To assemble the device, the two second parts 20b of the second connecting fitting 50 are positioned on the first parts 10b in such a way that the bearing edge 21 is arranged in the receptacle 11 in each case. Then, the second furniture part 2 can be pivoted relative to the first furniture part 1, wherein the pivot axis is predetermined by the bearing edge 21 and the receptacle 11. The pivoting takes place until the sliding surface 26 on the projection 27 meets the guide surface 15, so that then, in addition to the pure pivoting movement, a sliding movement takes place which has a directional component in the radial direction with respect to the pivot axis. As a result of this slight lifting of the second furniture part compared to a pure pivoting movement, the projection 27 travels along the guide surface 15 until the recess 17 is reached. Then, the projection 27 engages the recess 17 and the second furniture part 2 is lowered relative to the first furniture part 1 until the bearing edges 21 abut the two parts 20b in the receptacle 11. At the first connecting fitting 40, the second part 20b of the first connecting fitting 40 is locked against pivoting movement because the projection 27 engages in the recess 17.

### LIST OF REFERENCE SIGNS

1 First piece of furniture
2 Second piece of furniture
3 Connecting fitting
5 Piece of furniture
10, 10a, 10b First part
11 Receptacle
12 Web
13, 13a, 13b Base surface
14 Opening
15 Guide surface
16 Bend
17 Recess
20, 20a, 20b Second part
21 Bearing edge
22 Centering projection
23, 23a, 23b Base area
24 Opening
24 Opening
26 Sliding surface
27 Projection
28 Step
29 Bend
30 Connecting fitting
40 Connecting fitting
50 Connecting fitting
110 First part
111 Receptacle
114 Opening
120 Second part
121 Bearing edge
122 Centering projection
124 Opening
129 Bend
131 Abutment

1. A connecting fitting (3) for a piece of furniture (5), comprising:
a first part (10) which is configured to be fixed to a first furniture part (1),
a second part (20) which is configured to be fixed to a second furniture part (2), wherein the first part (10) has a receptacle (11) for a bearing edge (21) of the second part (20) and the second part (20) is pivotable relative to the first part (10) about the bearing edge (21) in a first angular range,
a guide surface (15) provided on the first part (10), which guide surface (15) contacts the second part (20) with a sliding surface (26) during pivoting in a second angular range and additionally displaces the second part (20) in translation relative to the first part (10), and
a locking element at the end of the guide surface (15), wherein the locking element is configured for locking the second part (20) against pivoting.

2. The connecting fitting according to claim 1, wherein the locking element is formed as a recess (17) into which a projection (27) of the second part (20) is insertable.

3. The connecting fitting according to claim 1, wherein the first part (10) has a bent web on which the guide surface (15) is formed.

4. The connecting fitting according to claim 1, wherein the first part (10) comprises a U-shaped or L-shaped bent receptacle (11).

5. The connecting fitting according to claim 1, wherein the second part (20) has an opening (25) into which a bent web with the guide surface (15) of the first part (10) is insertable.

6. The connecting fitting according to claim 5, wherein a projection (27) is formed on the opening (25) and is insertable into the recess (17) on the first part (10).

7. The connecting fitting according to claim 1, wherein the bearing edge (21) of the second part (20) is arranged between two centering projections (22), wherein the centering projections (22) engage around the receptacle (11) on the first part (10) during pivoting.

8. The connecting fitting according to claim 1, wherein the first part (10) has a flat base surface (13) to which the first furniture part (1) is fixable via fastening means.

9. The connecting fitting according to claim 1, wherein the second part (20) has a flat base surface (23) to which the second furniture part (2) is fixable via fastening means.

10. The connecting fitting according to claim 1, wherein the first part (10) and/or the second part (20) is or are made of a bent metal sheet.

11. A piece of furniture (5) having a first furniture part (1) and a second furniture part (2), which are fixed to each other via at least one connecting fitting (3) according to claim 1.

12. The piece of furniture according to claim 11, wherein the second furniture part (2) is fixed to the first furniture part (1) via a first connecting fitting (3) and a further connecting fitting (30), wherein both connecting fittings (3, 30) are mountable via a single pivoting movement.

13. A device for connecting furniture parts, comprising:
a first connecting fitting (3, 40) having a first part (10, 10a) which can be fixed to a first furniture part (1) and a second part (20, 20a) which can be fixed to a second furniture part (2), and
a second connecting fitting (30, 50) having a first part (10b, 110) which can be fixed to the first furniture part (1) and a second part (20b, 120) which can be fixed to the second furniture part (2),
wherein the first part (10b, 110) of the second connecting fitting (30, 50) comprises a receptacle (11, 111) for a bearing edge (21, 121) of the second part (20b, 120) of the second connecting fitting (30, 50), and the second part (20b, 120) can be pivoted relative to the first part (110) about the bearing edge (21, 121) in a first angular range,
wherein a guide surface (15) is provided on the first part (10, 10a) of the first connecting fitting (3, 40), which guide surface (15) connects the second part (20a, 20) of the first connecting fitting (3, 40) to a sliding surface (26) during pivoting and additionally displaces the second part (20, 20a) of the first connecting fitting in translation relative to the first part (10, 10a) of the first connecting fitting, and the first part (10, 10a) of the first connecting fitting has a locking element at the end of the guide surface (15), on which the second part (20, 20a) of the first connecting fitting can be locked against pivoting.

14. The device for connecting furniture parts according to claim 13, wherein the first part of the first connecting fitting (3) connecting fitting (30) has a receptacle (11) for a bearing edge (21) of the second part (20) of the first connecting fitting and the second part (20) of the first connecting fitting is pivotable relative to the first part (10) of the first connecting fitting about the bearing edge (21) in a second angular range.

15. The device according to claim 13, wherein when pivoting about the bearing edge (21), the translational displacement along the guide surface (15) takes place at least partially in a radial direction with respect to the bearing edge (21) formed as a pivot axis.

16. A method for assembling a piece of furniture (5) having a first furniture part (1) to which a first part (10) is fixed and a second furniture part (2) to which a second part (20) of a connecting fitting (3) is fixed, comprising the following steps:
placing a bearing edge (21) of the second part (20) against a receptacle (11) of the first part (10);
pivoting the second part (20) relative to the first part (10);
moving a sliding surface (26) on the second part (20) along a guide surface (15) on the first part (10) during said pivoting, wherein the second part (20) is additionally displaced in translation relative to the first part (10), and
locking the second part (20) to the first part (10) at an end of the guide surface (15) against a pivoting movement.

17. The method according to claim 16, wherein the step of locking is performed by engaging a projection (27) on an opening (50) of the second part (20) in a recess (17) on the first part (10).

18. The method for assembling a piece of furniture (5) having a first furniture part (1) to which a first part (10) is fixed and a second furniture part (2) to which a second part (20) of a connecting fitting (3) is fixed, and also comprising a second connecting fitting (30) having a first part (110) which can be fixed to the first furniture part (1) and a second part (120) which can be fixed to the second furniture part (2), comprising the following steps:
placing a bearing edge (121) of the second part (120) of the second connecting fitting (30) to a receptacle (111) of the first part (110) of the second connecting fitting (30);
pivoting the second part (120) relative to the first part (110); moving a sliding surface (26) on the second part (20) of the first connecting fitting (3) along a guide surface (15) on the first part (10) of the first connecting fitting (3) during said pivoting, wherein the second part (20) is additionally displaced in translation relative to the first part (10), and
locking the second part (20) to the first part (10) at the end of the guide surface (15) against a pivoting movement.

19. The method according to claim 18, wherein the translational displacement relative to the pivot axis formed by the bearing edge (21) takes place at least partially in a radial direction.

20. The method according to claim 18, wherein the translational displacement takes place at least partially perpendicular to a radial direction with respect to a pivot axis formed by the bearing edge (121).
